(19) United States
(12) Patent Application Publication
(10) Pub. No.: US 2007/0008342 A1
(43) Pub. Date: Jan. 11, 2007

(54) Segmentation refinement

(75) Inventors: Ramanathan Sethuraman, Eindhoven (NL); Christiaan Varekamp, Eindhoven (NL); Fabian Edgar Ernst, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,385

(22) PCT Filed: Apr. 27, 2004
(86) PCT No.: PCT/IB04/50525

§ 371 Date: Oct. 25, 2005

(30) Foreign Application Priority Data
Apr. 29, 2003 (EP) 03101178.6

(51) Int. Cl. G09G 5/00

(52) U.S. Cl. 345/635

(57) ABSTRACT

A method of converting of a first set (100a) of initial segments of an image into a second set of updated segments (A′,B′,C′,D′) is disclosed. The method comprises iterative updates of intermediate segments (A,B,C,D) being derived from respective initial segments. Each update comprises determining whether a pixel (300) should be moved from a first intermediate segment (A) to a second intermediate segment (B), on basis of a pixel value of the pixel, on basis of a first parameter of the intermediate segment (A) and on basis of a second parameter of the second intermediate segment (B). The iterative updates are performed on block base. That means that first a number of iterative updates are performed for pixels of a first two-dimensional block of pixels (200) of the image and after that the number of iterative updates are performed for pixels of a second two-dimensional block of pixels (204) of the image.

The invention relates to a method of converting of a first set of initial segments of an image into a second set of updated segments of the image, the method comprising iterative updates of intermediate segments being derived from respective initial segments, a particular update comprising determining whether a particular pixel being located at a border between a first one of the intermediate segments and a second one of the intermediate segments, should be moved from the first one of the intermediate segments to the second one of the intermediate segments, on basis of a pixel value of the particular pixel, on basis of a first parameter of the first one of the intermediate segments and on basis of a second parameter of the second one of the intermediate segments.

The invention further relates to a conversion unit arranged to perform such a method of converting.

The invention further relates to an image processing apparatus, comprising:

receiving means for receiving a signal representing an image;

a segmentation unit for determining a first set of initial segments of the image;

a conversion unit for converting the first set of initial segments into a second set of updated segments; and

an image processing unit for processing the image on basis of the second set of updated segments.

Image segmentation is an important first step that often precedes other tasks such as segment based depth estimation or video compression. Generally, image segmentation is the process of partitioning an image into a set of non-overlapping parts, or segments, that together correspond as much as possible to the physical objects that are present in the scene. There are various ways of approaching the task of image segmentation, including histogram-based segmentation, edge-based segmentation, region-based segmentation, and hybrid segmentation.

The method of the kind described in the opening paragraph is known in the art. With this known method a first set of initial segments of an image is converted into a second set of updated segments of the image. The method comprises iterative updates of intermediate segments being derived from respective initial segments. An update comprises determining whether a particular pixel being located at a border between a first intermediate segment and a second intermediate segment should be moved from the first intermediate segment to the second intermediate segment. This is based on the color value of the particular pixel, the mean color value of the first intermediate segment and on basis of the mean color value of the second intermediate segment. If it appears that the particular pixel should be moved from the first intermediate segment to the second intermediate segment new mean color values are computed for the new intermediate segments. Subsequently a next pixel is evaluated and optionally moved. After evaluation of the relevant pixels of the image in one scan over the image, another scan of evaluations over the image is started.

The known method however suffers from the fact that several segmentation refinement iterations of the complete image have to be performed for realizing pixel-precise segmentation. Typically, twenty scans over the image are made to achieve the second set of updated segments of the image. This approach is therefore very expensive in terms of memory access, power consumption and computational effort.

It is an object of the invention to provide a method of the kind described in the opening paragraph which is relatively efficient with regard to memory access.

This object of the invention is achieved in that first a number of iterative updates are performed for pixels of a first two-dimensional block of pixels of the image and after that the number of iterative updates are performed for pixels of a second two-dimensional block of pixels of the image. Typically the dimensions of the blocks of pixels are 8*8 or 16*16 pixels. The evaluations are performed for the relevant pixels in a block in a number of scans. That means that, e.g. row by row these relevant pixels in the block under consideration a evaluated and after that again relevant pixels of that block are evaluated. Note that the parameters of the segments are adapted after each evaluation. After the relevant pixels of a block of pixels have been evaluated in a number of scans, the pixel values of another block of pixels are evaluated in a similar way. With relevant pixels is meant those pixels which are located at a border between two segments. Note that a border moves, i.e. the edge of a segment changes, if a pixel is taken from an intermediate segment and added to its neighboring intermediate segment. Therefor the relevant pixels of a block is different for each of the scans.

An advantage of the method according to the invention is that a sliding window, comprising the pixels of subsequent blocks, is moved over the image only once. That means that the blocks of pixels have to be accessed only once from a memory device. Typically the pixel values of a block under consideration are temporarily stored in a cache. Then the iterations are performed on basis of the values in the cache.

In an embodiment of the method according to the invention, the first parameter corresponds to a mean color value of the first intermediate segment, the second parameter corresponds to a mean color value of the second intermediate segment and the pixel value of the particular pixel represents the color value of the particular pixel. Color is a relatively good criterion for image segmentation. An advantage of this embodiment according to the invention is that the updated segments relatively well correspond to objects in the scene.

In an embodiment of the method according to the invention, the particular update is based on a regularization term depending on the shape of the first one of the intermediate segments, the regularization term being computed on basis of a first group of pixels of the first two-dimensional block of pixels. In other words, the regularization term depends on the shape of the boundary between segments. The regularization term penalizes irregular segment boundaries. An advantage of this embodiment according to the invention is that relatively regular segment boundaries are determined. Therefor this embodiment according to the invention is less sensitive to noise in the image.

In an embodiment of the method according to the invention, a first sequence of the number of iterative updates are performed in a row-by-row scanning within the first block of pixels and a second sequence of the number of iterative updates are performed in a column-by-column scanning within the first block of pixels. In other words, the scanning directions are alternated between successive scans. For instance, first a scan in a horizontal direction is performed and then in vertical direction. Alternatively, first a scan in a vertical direction is performed and then in horizontal direction. Optionally, a third scan is in the opposite direction of the first scan, e.g. left-to-right versus right-to-left. Optionally, a fourth scan is in the opposite direction of the second scan, e.g. top-to-bottom versus bottom-to-top. Preferably the values of the regularization terms are different for the various scans, e.g. starting from a low curvature penalty to a high curvature penalty.

In an embodiment of the method according to the invention the first two-dimensional block of pixels is located adjacent to the second two-dimensional block of pixels. An advantage of this embodiment according to the invention is that a relatively simple memory allocation scheme is achieved.

In an embodiment of the method according to the invention the regularization term is computed on basis of the first group of pixels of the first two-dimensional block of pixels and a second group of pixels of the second two-dimensional block of pixels. By also taking into account pixels of a neighboring block of pixels a better regularization term can be computed for pixels at the border of a block.

It is a further object of the invention to provide a conversion unit of the kind described in the opening paragraph which is relatively efficient with regard to memory access.

This object of the invention is achieved in that the conversion unit comprises computation means for performing first a number of iterative updates for pixels of a first two-dimensional block of pixels of the image and for, after that, performing the number of iterative updates for pixels of a second two-dimensional block of pixels of the image.

It is advantageous to apply an embodiment of the conversion unit according to the invention in an image processing apparatus as described in the opening paragraph. The image processing apparatus may comprise additional components, e.g. a display device for displaying the processed images or storage means for storage of the processed images. The image processing unit might support one or more of the following types of image processing:

Video compression, i.e. encoding, e.g. according to the MPEG standard or H26L standard; or

Conversion of traditional monoscopic video (2D) video material into 3D video for viewing on a stereoscopic (3D) television. In this technology, structure from motion methods can be used to derive a depth map from two consecutive images in the video sequence; or

Image analysis for e.g. vision-based control like robotics or security applications.

Modifications of the method and variations thereof may correspond to modifications and variations thereof of the conversion unit and of the image processing apparatus described.

These and other aspects of the method, of the conversion unit and of the image processing apparatus according to the invention will become apparent from and will be elucidated with respect to the implementations and embodiments described hereinafter and with reference to the accompanying drawings, wherein:

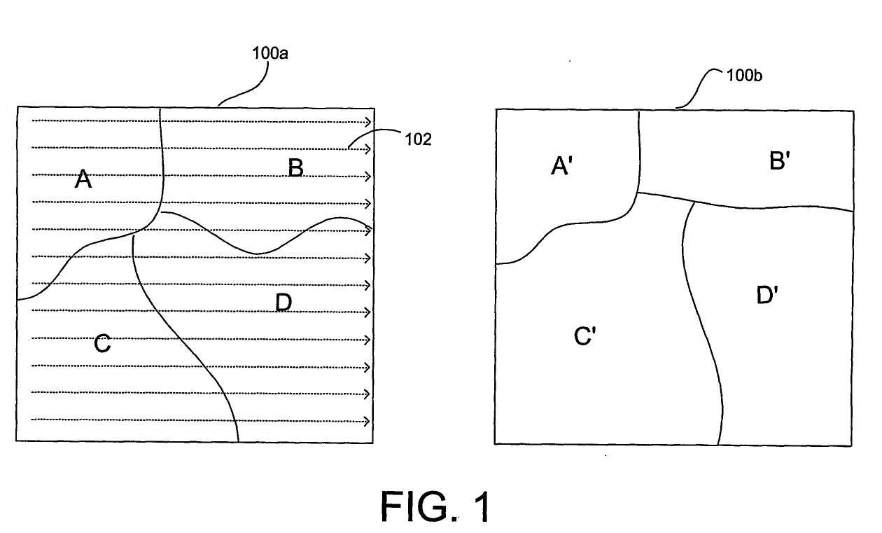

FIG. 1 schematically shows the scanning scheme according to the prior art;

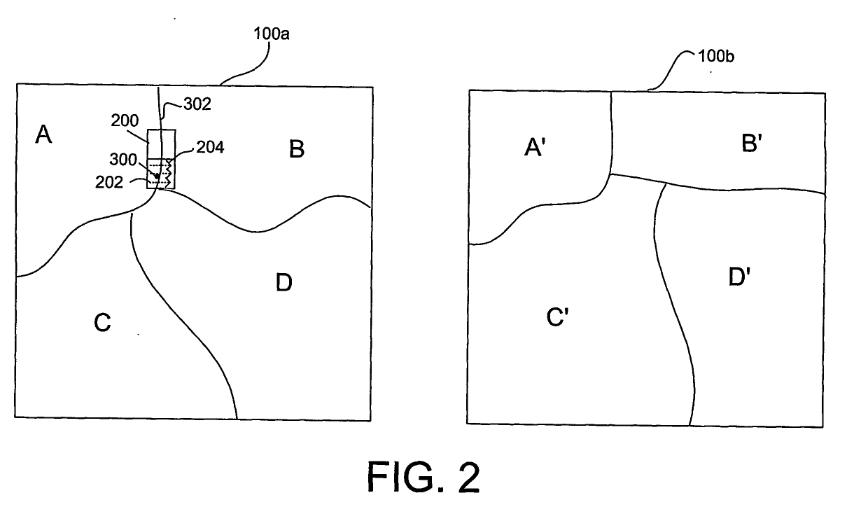

FIG. 2 schematically shows the scanning scheme according to the invention;

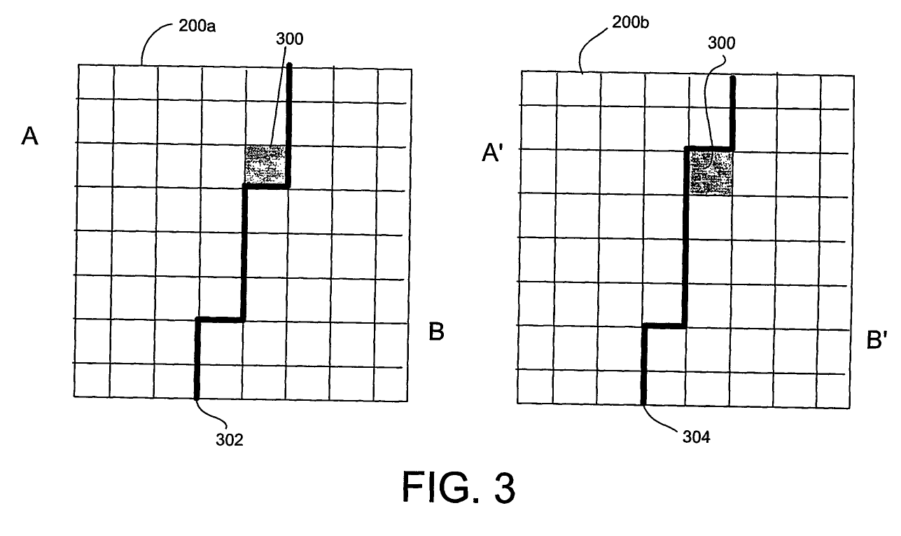

FIG. 3 schematically shows the update of two neighboring intermediate segments;

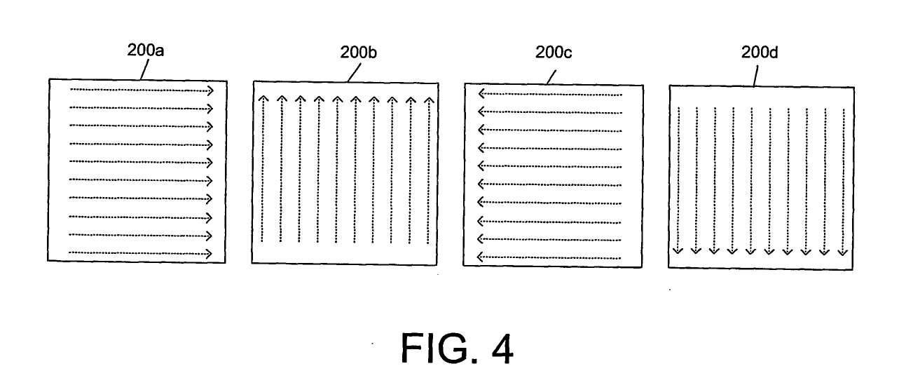

FIG. 4 schematically shows subsequent scanning directions for a block of pixels;

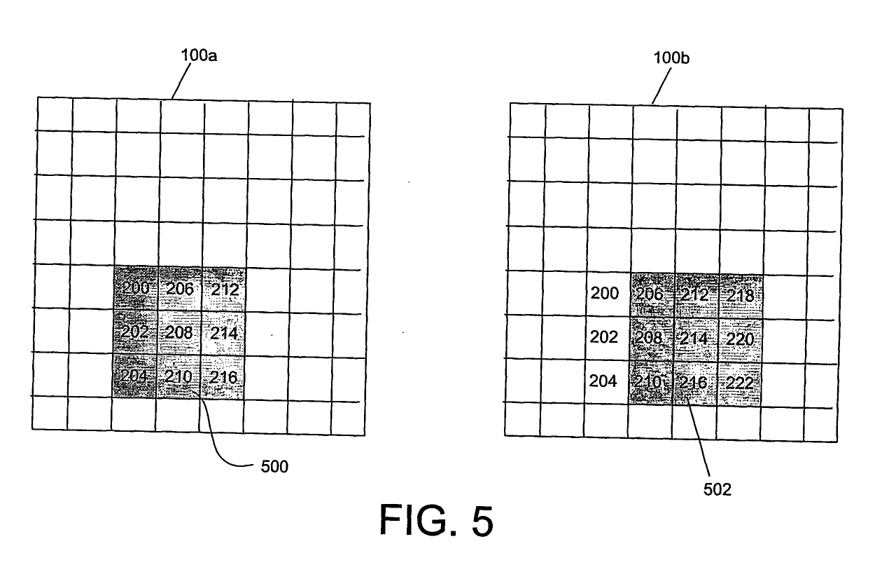

FIG. 5 schematically shows a sliding window of a number of blocks;

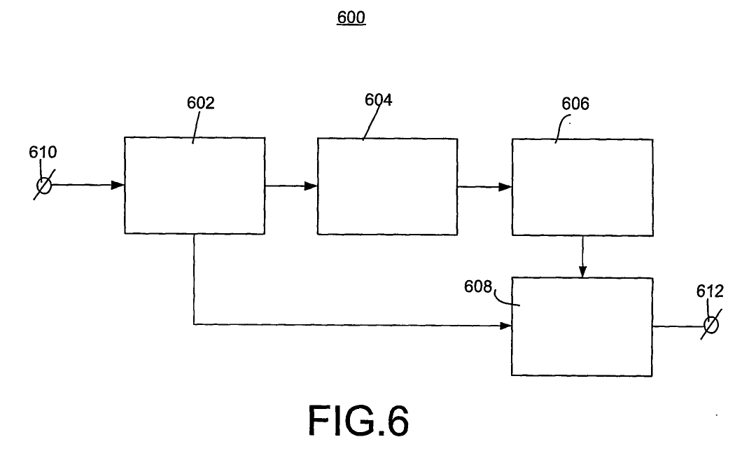

FIG. 6 schematically shows an image processing apparatus according to the invention; and

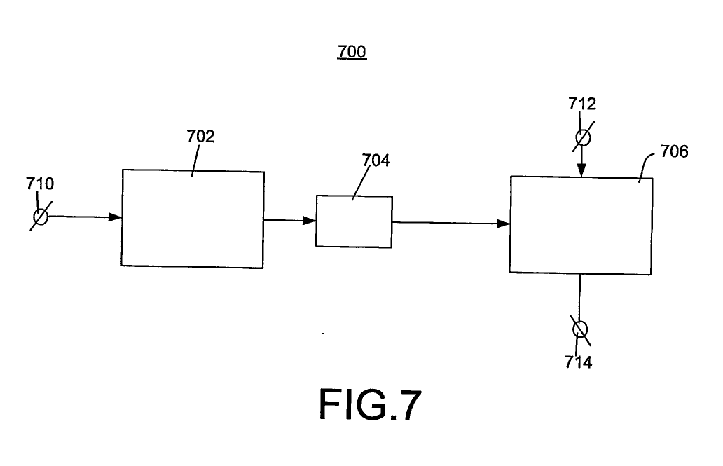

FIG. 7 schematically shows a number of components in the context of a conversion unit according to the invention.

Same reference numerals are used to denote similar parts throughout the figures.

An important step in converting 2D video to 3D video is the identification of image segments or regions with homogeneous color, i.e., image segmentation. Depth discontinuities are assumed to coincide with the detected edges of homogeneous color regions. A single depth value is estimated for each color region. This depth estimation per region has the advantage that there exists per definition a large color contrast along the region boundary. The temporal stability of color edge positions is critical for the final quality of the depth maps. When the edges are not stable over time, an annoying flicker may be perceived by the viewer when the video is shown on a 3D color television. Thus, a time-stable segmentation method is the first step in the conversion process from 2D to 3D video. Image segmentation using a constant color model achieves this desired effect. This method of image segmentation is described in greater detail below. It is based on a first set of initial segments and iterative updates resulting in a second set of updated segments. In other words the segmentation is a conversion of a first set of initial segments into a second set of updated segments.

The constant color model assumes that the time-varying image of an object segment can be described in sufficient detail by the mean region color. An image is represented by a vector-valued function of image coordinates:
I(x,y)=[r(x,y),g(x,y),b(x,y)] (1)
where r(x,y), g(x,y) and b(x,y) are the red, green and blue color channel. The object is to find a region partition referred to as segmentation L consisting of a fixed number of segments N. The optimal segmentation Lₒₚₜ is defined as the segmentation that minimizes the sum of an error term e(x,y) plus a regularization term ƒ(x,y) over all pixels in the image:

$${L}_{opt} = arg {min}_{L} {\sum }_{( x , y )} e ( x , y ) + k {\sum }_{( x , y )} f ( x , y ) \qquad ( 2 )$$

where k is a regularization parameter that weights the importance of the regularization term. In the book “Pattern Classification”, by Richard O. Duda, Peter E. Hart, and David G. Stork, pp. 548-549, John Wiley and Sons, Inc., New York, 2001 equations are derived for a simple and efficient update of the error criterion when one sample is moved from one cluster to another cluster. These derivations were applied in deriving the equations of the segmentation method. The regularization term is based on a measure presented in the book “Understanding Synthetic Aperture Radar Images” by C. Oliver, S. Quegan, Artech-House, 1998. The regularization term limits the influence that random signal fluctuations, such as sensor noise, have on the edge positions. The error e(x,y) at pixel position (x,y) depends on the color value I(x,y) and on the segment label L(x,y):
e(x,y)=∥I(x,y)−m_{L(x,y)}∥₂² (3)
where m_{L(x,y)} is the mean color for the segment with label L(x,y). The subscript at the double vertical bars denotes the Euclidean norm. The regularization term ƒ(x,y) depends on the shape of the boundary between segments:

$$f ( x , y ) = {\sum }_{( {x}^{′} , {y}^{′} )} x ( L ( x , y ) , L ( {x}^{′} , {y}^{′} ) \qquad ( 4 )$$

where (x′,y′) are coordinates from the 8-connected neighbor pixels of (x,y). The value of x(A,B) depends on whether segment labels A and B differ:

$$x ( A , B ) = \{ \begin{matrix}1 & if A \neq B \\ 0 & otherwise\end{matrix} \qquad ( 5 )$$

Function ƒ(x,y) has a straightforward interpretation. For a given pixel position (x,y), the function simply returns the number of 8-connected neighbor pixels that have a different segment label.

Given the initial segmentation, a change is made at a segment boundary by assigning a boundary pixel to an adjoining segment. Suppose that a pixel with coordinates (x,y) currently in segment with label A is tentatively moved to segment with label B. Then the change in mean color for segment A is:

$$Δ {m}_{A} = - \frac{I ( x , y ) - {m}_{A}}{{n}_{A} - 1} \qquad ( 6 )$$

and the change in mean color for segment B is:

$$Δ {m}_{B} = \frac{I ( x , y ) - {m}_{B}}{{n}_{B} + 1} \qquad ( 7 )$$

where n_{A} and n_{B} are the number of pixels inside segments A and B respectively. The proposed label change causes a corresponding change in the error function given by

$$Δ {\sum }_{( x , y )} e ( x , y ) = \frac{{n}_{B}}{{n}_{B} + 1} {‖ I ( x , y ) - {m}_{B} ‖}_{2}^{2} - \frac{{n}_{A}}{{n}_{A} - 1} {‖ I ( x , y ) - {m}_{A} ‖}_{2}^{2} \qquad ( 8 )$$

The proposed label change from A to B at pixel (x,y) also changes the global regularization function ƒ. The proposed move affects ƒ not only at (x,y), but also at the 8-connected neighbor pixel positions of (x,y). The change in regularization function is given by the sum

$$\begin{matrix}\begin{matrix}Δ k {\sum }_{( x , y )} f ( x , y ) = k Δ {\sum }_{( x , y )} f ( x , y ) \\ = 2 {\sum }_{( {x}^{ ′} {y}^{ ′} )} [ x ( B , L ( {x}^{ ′} , {y}^{ ′} ) ) - x ( A , L ( {x}^{′} , {y}^{′} ) ) ]\end{matrix} & ( 9 )\end{matrix}$$

where (x′,y′) are the 8-connected neighbor pixels of(x,y).

The proposed label change improves the fit criterion if

$$Δ {\sum }_{( x , y )} e ( x , y ) + k Δ {\sum }_{( x , y )} f ( x , y ) < 0 \qquad ( 10 )$$

FIG. 1 schematically shows the scanning scheme according to the prior art. FIG. 1 shows image with intermediate segments A,B,C and D being derived from initial segments from the beginning of the conversion and the same image with the updated segments A′,B′,C′ and D′. The pixels of image are evaluated in a line-by-line scanning as indicated with the arrows, e.g. arrow 102. After one scan over the image a subsequent scan over the image is performed. The evaluation is based on the evaluation of color models as described above.

FIG. 2 schematically shows the scanning scheme according to the invention. FIG. 2 shows an image with intermediate segments A,B,C and D being derived from initial segments from the beginning of the conversion and the same image with the updated segments A′,B′,C′ and D′. The pixels of the image are evaluated in a block by block scheme. That means that first a number of iterative evaluations are performed for the relevant pixels within a first block 200. After that a number of iterative evaluations are performed for the relevant pixels within a second block 202. The direction of the scanning within a block might be as depicted with arrow 204, i.e. row-by-row. The evaluations are based on the evaluation of color models as described above.

FIG. 3 schematically shows the update of two neighboring intermediate segments A and B into A′ and B′, respectively. FIG. 3 schematically shows a block 200a of 8*8 pixels which is located at a border 302 between a first intermediate segment A and a second intermediate segment B. The pixel 300 with coordinates (x,y) is evaluated. That means it is determined whether pixel 300 should be moved to segment B. The evaluation is based on the computations as specified in Equations 6-9. On basis of the evaluation the pixel 300 is moved. FIG. 3 also shows the same block 200b of 8*8 pixels being located at a border 304 between a third intermediate segment A′ and a fourth intermediate segment B′. The third intermediate segment is derived from the first intermediate segment A and the fourth intermediate segment B′ is derived from the second intermediate segment B.

FIG. 4 schematically shows subsequent scanning directions for a block of pixels. The scanning over the pixels in a block for the evaluation might be alternatingly in a horizontal 200a, 200c and vertical direction 200b, 200d. Besides that the scanning can be from left-to-right 200a and vice versa 200c. Besides that the scanning can be from top-to-bottom 200d and from bottom-to-top 200b. Besides that, a not depicted, zigzag scan is possible.

FIG. 5 schematically shows a sliding window 500 of a number of blocks 200-216. Typically these blocks 200-216 are simultaneously cached when the pixels of the central block 208 are evaluated. The neighboring blocks 200-206 and 210-216 are required for the computation of the regularization term as specified in Equation 4. After all evaluations have been performed for the central block 208 a new window 502 is defined within the image. This new window comprises the blocks 206-222. The central block 214 of this window will be evaluated now. It should be noted that if there is no edge within a block that then that block will be skipped and the window is moved further. Within a block only those pixels which are located at the border of a segment are evaluated.

FIG. 6 schematically shows an image processing apparatus 600 according to the invention, comprising:

receiving means 602 for receiving a signal representing video images;

a segmentation unit 604 for determining a first set of initial segments of one of the video images;

a conversion unit 606 for converting the first set of initial segments into a second set of updated segments A′,B′,C′,D′; and

an image processing unit 608 for processing the video image 110b on basis of the second set of updated segments A′,B′,C′,D′.

The input signal may be a broadcast signal received via an antenna or cable but may also be a signal from a storage device like a VCR (Video Cassette Recorder) or Digital Versatile Disk (DVD). The input signal is provided at the input connector 610. The image processing apparatus 600 provides the output at the output connector 612.

The conversion unit 604 for converting the first set of initial segments into a second set of updated segments may be implemented using one processor. Normally, this function is performed under control of a software program product. During execution, normally the software program product is loaded into a memory, like a RAM, and executed from there. The program may be loaded from a background memory, like a ROM, hard disk, or magnetically and/or optical storage, or may be loaded via a network like Internet. Optionally an application specific integrated circuit provides the disclosed functionality.

The segmentation unit 604, the conversion unit 606 and the image processing unit 608 can be combined into one processor.

The output might be a stream of compressed video data. Alternatively the output represents 3D video content. The conversion of the received video images into the 3D video content might be as disclosed by M. Op de Beeck and A. Redert, in “Three dimensional video for the home”, in Proceedings of the International Conference on Augmented Virtual Environments and Three-Dimensional Imaging, Myconos, Greece, 2001, pp 188-191.

The image processing apparatus 600 might e.g. be a TV. The image processing apparatus 600 might comprise a display device. Alternatively the image processing apparatus 600 does not comprise the optional display device but provides the output data to an apparatus that does comprise a display device. Then the image processing apparatus 600 might be e.g. a set top box, a satellite-tuner, a VCR player, a DVD player or recorder. The image processing apparatus 600 might also be a system being applied by a film-studio or broadcaster.

Optionally the image processing apparatus 600 comprises storage means, like a hard-disk or means for storage on removable media, e.g. optical disks.

FIG. 7 schematically shows a number of components 702, 704 in the context of a conversion unit 706 according to the invention. The system 700 comprises a memory device for storage of image data, e.g. the luminance and color values of the pixels of the images. This image data is provided to the first input connector 710. The system 700 further comprises a conversion unit 706 which is arranged to convert a first set of initial segments of an image into a second set of updated segments A′,B′,C′,D′. This conversion is done by means of iterative updates of intermediate segments A,B,C,D being derived from respective initial segments, whereby a particular update comprises determining whether a particular pixel 300 being located at a border 302 between a first one of the intermediate segments A, and a second one of the intermediate segments B, should be moved from the first one of the intermediate segments A to the second one of the intermediate segments B, on basis of a color value of the particular pixel, on basis of the mean color value of the first one of the intermediate segments A and on basis of the mean color value of the second one of the intermediate segments B. The first set of initial segments of an image are provided at the second input connector 712 and the second set of updated segments A′,B′,C′,D′ are at the output connector 714.

The conversion unit 706 comprises computation means for performing first a number of iterative updates for pixels of a first two-dimensional block of pixels 208 of the image and for, after that, performing the number of iterative updates for pixels of a second two-dimensional block of pixels 214 of the image. The pixels of the blocks 200-216 are simultaneously cached within the cache 704 when the pixels of the central block 208 are evaluated. After all evaluations have been performed for the central block 208 a new window 502 is defined within the image. This new window comprises the blocks 206-222. The central block 214 of this window will be evaluated now.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word ‘comprising’ does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the unit claims enumerating several means, several of these means can be embodied by one and the same item of hardware.

1. A method of converting of a first set (100a) of initial segments of an image into a second set (100b) of updated segments (A′,B′,C′,D′) of the image, the method comprising iterative updates of intermediate segments (A,B,C,D) being derived from respective initial segments, a particular update comprising determining whether a particular pixel (300) being located at a border (302) between a first one of the intermediate segments (A), and a second one of the intermediate segments (B), should be moved from the first one of the intermediate segments (A) to the second one of the intermediate segments (B), on basis of a pixel value of the particular pixel, on basis of a first parameter of the first one of the intermediate segments (A) and on basis of a second parameter of the second one of the intermediate segments (B), characterized in that first a number of iterative updates are performed for pixels of a first two-dimensional block of pixels (200) of the image and after that the number of iterative updates are performed for pixels of a second two-dimensional block of pixels (204) of the image.

2. A method of converting as claimed in claim 1, characterized in that the first parameter corresponds to a mean color value of the first intermediate segment, the second parameter corresponds to a mean color value of the second intermediate segment and the pixel value of the particular pixel represents the color value of the particular pixel.

3. A method of converting as claimed in claim 1, characterized in that the particular update is based on a regularization term depending on the shape of the first one of the intermediate segments, the regularization term being computed on basis of a first group of pixels of the first two-dimensional block of pixels.

4. A method of converting as claimed in claim 1, characterized in that a first sequence of the number of iterative updates are performed in a row-by-row scanning within the first block of pixels and a second sequence of the number of iterative updates are performed in a column-by-column scanning within the first block of pixels.

5. A method of converting as claimed in claim 1, characterized in that the first two-dimensional block of pixels is located adjacent to the second two-dimensional block of pixels.

6. A method of converting as claimed in claim 1, characterized in that the regularization term is computed on basis of the first group of pixels of the first two-dimensional block of pixels and a second group of pixels of the second two-dimensional block of pixels.

7. A conversion unit (706) for converting a first set (100a) of initial segments of an image into a second set (100b) of updated segments (A′,B′,C′,D′) of the image, the conversion unit being arranged to perform iterative updates of intermediate segments (A,B,C,D) being derived from respective initial segments, a particular update comprising determining whether a particular pixel (300) being located at a border (302) between a first one of the intermediate segments (A), and a second one of the intermediate segments (B), should be moved from the first one of the intermediate segments (A) to the second one of the intermediate segments (B), on basis of a pixel value of the particular pixel, on basis of a first parameter of the first one of the intermediate segments (A) and on basis of a second parameter of the second one of the intermediate segments (B), characterized in that the conversion unit (706) comprises computation means for performing first a number of iterative updates for pixels of a first two-dimensional block of pixels (200) of the image and for, after that, performing the number of iterative updates for pixels of a second two-dimensional block of pixels (204) of the image.

8. An image processing apparatus (600), comprising:
receiving means (602) for receiving a signal representing an image;
a segmentation unit (604) for determining a first set of initial segments of the image;
a conversion unit (606) for converting the first set of initial segments into a second set of updated segments, the conversion unit as claimed in claim 7; and
an image processing unit (608) for processing the image on basis of the second set of updated segments.

9. An image processing apparatus (600) as claimed in claim 8, whereby the image processing unit (608) is designed to perform video compression.
